(19) United States
(12) Patent Application Publication
(10) Pub. No.: US 2006/0215060 A1
(43) Pub. Date: Sep. 28, 2006

(54) Video processing apparatus and computer system integrated with the same

(75) Inventors: Ming-Hou Dai, Chung Ho City (TW); Wen-Chien Chang, Chung Ho City (TW); Jui-Hsiang Yang, Chung Ho City (TW)

Correspondence Address: BIRCH STEWART KOLASCH & BIRCH, PO BOX 747, FALLS CHURCH, VA, 22040-0747, US

(73) Assignee: AverMedia TECHNOLOGIES, INC.

(21) Appl. No.: 11/186,792

(22) Filed: Jul. 22, 2005

(30) Foreign Application Priority Data
Mar. 24, 2005 (TW) 94109167

(51) Int. Cl. H04N 5/45

(52) U.S. Cl. 348/565

(57) ABSTRACT

A video processing apparatus is described. The video processing apparatus includes a video decoder, a deinterlacer, a PIP (picture-in-picture) module and a PIP characteristic controller. The video decoder receives a video signal and decodes the video signal into a digital video signal. The deinterlacer receives the digital video signal and generates a non-interlacing signal. The PIP module overlaps the non-interlacing signal, in response to a PIP characteristic signal, with a screen signal and generates a PIP video that can be played by a display. The PIP characteristic controller generates the PIP characteristic signal in response to a PIP command. The PIP command comes from a computer. The deinterlacer and the PIP module are realized by hardware.

### RELATED APPLICATIONS

The present application is based on, and claims priority from, Taiwan Application Serial Number 94109167, filed Mar. 24, 2005, the disclosure of which is hereby incorporated by reference herein in its entirety.

### BACKGROUND OF THE INVENTION

1. Field of Invention

The invention relates to a video processing apparatus and, in particular, to a video processing apparatus that uses the display of a computer to display TV video.

2. Related Art

In the past, a TV card is used to convert a TV signal into a signal that is compliant with a universal computer interface (e.g. the PCI interface). The user can then watch TV programs using the display of a computer.

The process of converting a TV signal into a computer-displaying signal involves deinterlacing. After digitalizing the TV signal, the computer uses software to deinterlace the TV signal and shows it in a picture-in-picture (PIP) screen on the display. The user can use the computer as well as watch the TV program in the PIP video at the same time. The computer may also compress the TV signal and store it in a hard disk drive (HDD) for future displays.

However, video processing involves a huge amount of computing power. Using the computer to perform deinterlacing will waste a lot of the computer resources. To reduce the burden, a simplified deinterlacing algorithm is often used in the past. However, the simplified deinterlacing algorithm would result in unsatisfactory video quality. Besides, it is slower to use software for deinterlacing. It may not produce sufficiently smooth images.

Therefore, it is imperative to provide a video processing apparatus that is fast, renders good-quality images, and does not occupy computer resources.

### SUMMARY OF THE INVENTION

An object of the invention is to provide a video processing apparatus that uses hardware to provide a faster deinterlacing speed and better image quality.

Another object of the invention is to provide a video processing apparatus that saves the resources of a computer when used along with the computer.

Yet another object of the invention is to provide a video processing apparatus that overlaps a deinterlaced signal with a screen signal and displays it PIP video on the display.

To achieve the above-mentioned objects, the video processing apparatus according to a preferred embodiment of the invention includes a video decoder, a deinterlacer, a PIP (picture-in-picture) module, and a PIP characteristic controller.

The video decoder receives a video signal and decodes the video signal into a digital video signal. The deinterlacer receives the digital video signal and generates a non-interlacing signal.

The PIP module receives the non-interlacing signal and a PIP characteristic signal. The PIP module overlaps the non-interlacing signal, in response to the PIP characteristic signal, with a screen signal and generates a PIP video that can be played by a display. The PIP characteristic signal controls the position and size of the PIP video. The screen signal is the background of the computer operating system (OS).

The PIP characteristic controller receives a PIP command. The PIP characteristic controller generates the PIP characteristic signal in response to the PIP command. The PIP command comes from a computer. The deinterlacer and the PIP module are realized by hardware.

In accord with the objects, the invention provides a video processing apparatus. According to a preferred embodiment of the invention, the video processing apparatus includes a video decoder, a deinterlacer, and a bridge.

The video decoder receives and decodes a video signal and generates a digital video signal. The deinterlacer receives the digital video signal and generates a non-interlacing signal. The bridge converts the non-interlacing signal into a computer video signal. The computer video signal complies with a universal computer interface format. The computer video signal is received by a computer and played by a display thereof.

Each embodiment of the invention has one or more advantages. The disclosed video processing apparatus uses hardware to provide a faster deinterlacing speed and better video quality. When being implemented on a computer, the invention saves the resources thereof because the computer does not need to perform deinterlacing jobs. The disclosed video processing apparatus can overlap a deinterlaced signal with a screen signal to present a PIP video on a display.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a block diagram of the video processing apparatus according to an embodiment of the invention; and

FIG. 2 is a block diagram of the video processing apparatus according to another embodiment of the invention.

### DETAILED DESCRIPTION OF THE PREFERRED EMBODIMENT

The present invention will be apparent from the following detailed description, which proceeds with reference to the accompanying drawings, wherein the same references relate to the same elements.

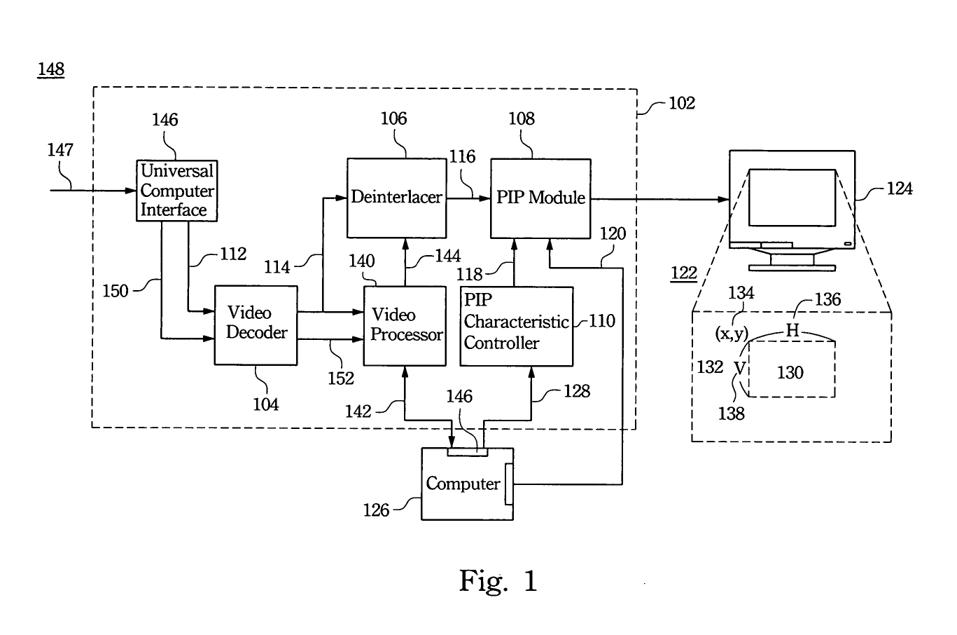

With reference to the block diagram in FIG. 1, the video processing apparatus 102 according to an embodiment includes a video decoder 104, a deinterlacer 106, a picture-in-picture (PIP) module 108, and a PIP characteristic controller 110. The video decoder 104 receives a video signal 112 and decodes the video signal 112 into a digital video signal 114. The deinterlacer 106 receives the digital video signal 114 and generates a non-interlacing signal 116.

The PIP module 108 receives the non-interlacing signal 116 and a PIP characteristic signal 118. The PIP module 108 overlaps the non-interlacing signal 116, in response to the PIP characteristic signal 118, with a screen signal 120 and generates a PIP video 122 that can be played by a display 124. The PIP characteristic signal 118 controls the position and size of the PIP video 122. The screen signal 120 is the background of the computer 126 operating system (OS).

The PIP characteristic controller 110 receives a PIP command 128. The PIP characteristic controller 110 generates the PIP characteristic signal 118 in response to the PIP command 128. The PIP command 128 comes from a computer 126. The deinterlacer 106 and the PIP module 108 are realized by hardware.

The user of the computer 126 utilizes the computer display 124 to display the video signal 112 (e.g. a TV signal) in the OS environment. Therefore, a PIP video 122 needs to be played on the display. The PIP video 122 contains the original video 132 of the OS and the playing video 130 of the video signal 112. The video signal 112 is used to generate the non-interlacing signal 116 by the deinterlacer. The user sends a command (the PIP command 128) via the computer 126 to assign the position 134 (such as the X and Y coordinates) and size (such as H136 and V 138) of the playing video 130 on the original video 132 of the OS.

The PIP characteristic controller 110 receives the PIP command 128 and, after decoding (compilation), generates a PIP characteristic signal 118 suitable for the PIP module 108. The PIP module 108 performs the video overlapping in response to the PIP characteristic signal 118, resulting in the PIP video 122.

In another embodiment, the video processing apparatus 102 includes a video processor 140. The video processor 140 receives the digital video signal 114 and generates a compressed video signal 142. The compressed video signal 142 is transmitted via a universal computer interface 146 to the computer 126 for storage.

The video processor 140 can be a MPEG codec. The video processor 140 encodes the digital video signal 114 into a code in the MPEG2 or MPEG4 format for storage in the computer 126. The video processor 140 may decode the compressed video signal 142 stored in the computer 126 to generate a decoded video signal 144. The decoded video signal 144 is deinterlaced and transmitted to the PIP module 108. The PIP module 108 overlaps the decoded signal 144 with the screen signal 120 to generate another PIP video. The universal computer interface may be a universal serial bus (USB), a PCI interface, an IEEE 1394 interface, or a PCI express (PCIe) interface.

In yet another embodiment, the video processing apparatus 102 includes a tuner 146, which receives a broadcasting signal 147 to generate the video signal 112 and perhaps an audio signal too. The video decoder 104 may contain an audio decoder, which decodes the audio signal 150 to generate a digital audio signal 152. The digital audio signal 152 may be stored in the computer 126 or directly played in a similar way as for the digital video signal.

The video processing apparatus 102 can be integrated into a computer system 148, including a computer 126 and a display 124. The computer system 148 may be a desktop computer or a laptop computer. The video processing apparatus 102 is built in the computer 126, the display 124, or in an externally connected box.

Since the deinterlacer 106 and the PIP module 108 are implemented by hardware, they have a faster deinterlacing speed and better video quality than software deinterlacing. Moreover, they do not occupy hardware and software resources of the computer 126.

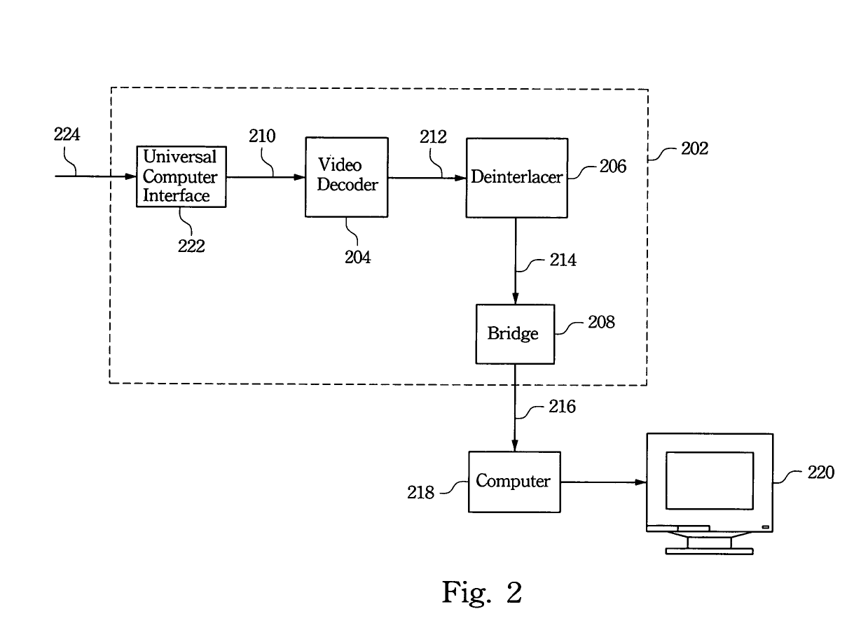

With reference to the block diagram shown in FIG. 2, the video processing apparatus 202 in another embodiment of the invention includes a video decoder 204, a deinterlacer 206, and a bridge 208.

The video decoder 204 receives a video signal 210 and decodes the video signal 210 into a digital video signal 212. The deinterlacer 206 receives the digital video signal 212 and generates a non-interlacing signal 214. The bridge 208 converts the non-interlacing signal 214 into a computer video signal 216. The computer video signal 216 complies with a universal computer interface format. After receiving the computer video signal 216, a computer displays the computer video signal 216 on a display 220.

The computer 218 may use a PIP screen to display the computer video signal 216. The above-mentioned universal computer interface format includes a USB, a PCI interface, an IEEE 1394, and a PCIe interface.

Usually the data size of the non-interlacing signal 216 after deinterlacing is larger than the digital video signal 212. When the computer 218 has a stronger operating power and a larger capacity, one may use this method to receive the non-interlacing signal 216. After the computer 218 receives the computer video signal 216, a PIP screen is formed by software and shown on the display 220. The computer video signal 216 may be compressed and stored in the computer 218 for future display on the display 220.

Each embodiment of the invention has one or more advantages. The disclosed video processing apparatus uses hardware to provide a faster deinterlacing speed and better video quality. When being implemented on a computer, the invention saves the resources thereof because the computer does not need to perform deinterlacing jobs. The disclosed video processing apparatus can overlap a deinterlaced signal with a screen signal to present a PIP video on a display.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A video processing apparatus, comprising:
a video decoder, which receives a video signal and decodes it to generate a digital video signal;
a deinterlacer, which receives the digital video signal to generate a non-interlacing signal;
a picture-in-picture (PIP) module, which receives the non-interlacing signal and a PIP characteristic signal to overlap the non-interlacing signal with the screen signal in response to the PIP characteristic signal, producing a PIP video for a display to play; wherein the PIP characteristic signal controls the location and size of the PIP video and the screen signal is the background of the computer operating system (OS); and
a PIP characteristic controller, which receives a PIP command, coming from a computer, to output the PIP characteristic signal according to the PIP command;
wherein the deinterlacer and the PIP module are implemented by hardware.

2. The video processing apparatus of claim 1 further comprising a video processor that receives the digital video signal to generate a compressed video signal, wherein the compressed video signal is transmitted via a universal computer interface to the computer for storage.

3. The video processing apparatus of claim 2, wherein the video processor includes a MPEG codec.

4. The video processing apparatus of claim 2, wherein the video processor decodes the compressed video signal stored in the computer to generate a decoded video signal, the decoded video signal is transmitted to the PIP module, and the PIP module overlaps the decoded video signal with the screen signal to produce another PIP video.

5. The video processing apparatus of claim 2, wherein the universal computer interface is selected from a group consisting of a universal serial bus (USB), a PCI interface, an IEEE 1394 interface and a PCI express (PCIe) interface.

6. The video processing apparatus of claim 1 further comprising a tuner that receives a broadcasting signal to generate the video signal.

7. A computer system, comprising:
a video decoder, which receives a video signal and decodes it to generate a digital video signal;
a deinterlacer, which receives the digital video signal to generate a non-interlacing signal;
a computer, which sends out a PIP command;
a display;
a PIP module, which receives the non-interlacing signal and a PIP characteristic signal and overlaps the non-interlacing signal with a screen signal in response to the PIP characteristic signal, producing a PIP video for the display to play; wherein the PIP characteristic signal controls the location and size of the PIP video and the screen signal is the background of the computer operating system (OS); and
a PIP characteristic controller, which receives a PIP command, coming from a computer, to output the PIP characteristic signal according to the PIP command;
wherein the deinterlacer and the PIP module are implemented by hardware.

8. The computer system of claim 7 further comprising a video processor that receives the digital video signal to generate a compressed video signal, wherein the compressed video signal is transmitted via a universal computer interface to the computer for storage.

9. The computer system of claim 8, wherein the video processor includes a MPEG codec.

10. The computer system of claim 8, wherein the video processor decodes the compressed video signal stored in the computer to generate a decoded video signal, the decoded video signal is transmitted to the PIP module, and the PIP module overlaps the decoded video signal with the screen signal to produce another PIP video.

11. The computer system of claim 8, wherein the universal computer interface is selected from a group consisting of a universal serial bus (USB), a PCI interface, an IEEE 1394 interface and a PCI express (PCIe) interface.

12. The computer system of claim 7 further comprising a tuner that receives a broadcasting signal to generate the video signal.

13. A video processing apparatus, comprising:
a video decoder, which receives a video signal and decodes it to generate a digital video signal;
a deinterlacer, which receives the digital video signal to generate a non-interlacing signal; and
a bridge, which converts the non-interlacing signal into a computer video signal that is compliant with a universal computer interface format;
wherein the computer video signal is received by a computer and played on a display.

14. The video processing apparatus of claim 13, wherein the computer uses a PIP screen to play the computer video signal.

15. The video processing apparatus of claim 13, wherein the universal computer interface is selected from a group consisting of a universal serial bus (USB), a PCI interface, an IEEE 1394 interface and a PCI express (PCIe) interface.

16. The video processing apparatus of claim 13 further comprising a tuner that receives a broadcasting signal to generate the video signal.
